(19) United States
(12) Patent Application Publication
(10) Pub. No.: US 2002/0048375 A1
(43) Pub. Date: Apr. 25, 2002

(54) Circuit housing for a headset

(76) Inventor: Wolf-Dietrich Bebenroth, Celle (DE)

Correspondence Address: REED SMITH LLP, 375 Park Avenue, New York, NY, 10152-1799, US

(21) Appl. No.: 09/942,522

(22) Filed: Aug. 29, 2001

(30) Foreign Application Priority Data
Aug. 29, 2000 (DE) 100 42 453.8

(51) Int. Cl. H04R 1/10; H04R 25/00

(52) U.S. Cl. 381/74; 381/384

(57) ABSTRACT

A circuit housing is disclosed having an electrical circuit for a headset, in particular for a chin loop headset. The housing has a cover which is in the form of an actuating element of the circuit.

### CROSS-REFERENCE TO RELATED APPLICATIONS

This application claims priority of application Ser. No. 100 42 453.8, filed Aug. 29, 2000.

### BACKGROUND OF THE INVENTION

a) Field of the Invention

The present invention concerns a circuit housing having an electrical circuit for a headset, in particular for a chin loop headset.

b) Description of the Related Art

As is known, headsets are generally made as light as possible in order to make them comfortable for the user. For that reason, the design of headsets as far as possible avoids mounting electrical circuits to the headset, while a signal output, for example on a stereo unit, supplies a signal which is already suitably prepared for the headset.

There are, however, areas of use in which additional functions of the headset require that an electrical circuit for the headset is also to be mounted to the headset—or at least in the region thereof—if, for example, the volume of the sound signal delivered by the headset is to be adjustable at the headset or if the signals are to be transmitted by means of infrared rays in order to eliminate a cable connection to the audio signal output.

DE 40 19 529 A1 describes, for example, a listen-talk unit with a headset and a circuit housing in which an electrical circuit for the headset is disposed. The housing is connected to the headset by way of a cable and on the outside has various different actuating elements and switches which overall result in the housing being of a complicated structure with many openings therein. U.S. Pat. No. 5,701,356 also describes a circuit housing with an electrical circuit for a headset, on which there is disposed an actuating element in the form of an outwardly projecting rotary knob.

Chin loop headsets, in particular, are known in the above-mentioned areas of use. Chin loop headsets have a small housing which can be positioned under the chin in front of the chest of the user and from which two elastic side pieces lead generally in a slightly arcuate configuration, past the cheeks, to the ears. Acoustic transducers are mounted there at the upper ends of the side pieces. The transducers are usually fitted with ear pads in order to cushion the pressure with which the transducers are pressed against the ears of the user gently and in a manner which is comfortable.

The usual design configuration of circuit housings for headsets gives rise to problems, in particular, in regard to the arrangement of elements for actuating the circuit. On the one hand, the circuit housing should be as small as possible in order to irritate and stress the user as little as possible but, on the other hand, a plurality of actuating elements are to be arranged on the circuit housing, in accordance with some operational demands. The actuating elements in turn should be, on the one hand, light and easily recognizable in terms of operation thereof but, on the other hand, they should not be such that they can be readily actuated inadvertently. In addition, at the latest with the demand for a plurality of actuating elements, the problem arises of the individual parts of the housing being of a structure which is complex and expensive from the production engineering point of view, as well as expensive assembly of the overall unit.

### OBJECT AND SUMMARY OF THE INVENTION

In comparison therewith, the primary object of the present invention is to provide a circuit housing having an electrical circuit for a headset, which is of a simpler structure from the point of view of production engineering and which is ergonomically improved.

In accordance with the invention, that object is attained by a circuit housing having an electrical circuit for a headset, in particular for a chin loop headset, comprising that the housing has a cover which is in the form of an actuating element of the circuit.

In accordance with the invention, a circuit housing having an electrical circuit for a headset has a cover which is in the form of an actuating element of the circuit. In accordance with the invention, that has the advantage in terms of production engineering that, after assembly of the circuit in the initially open circuit housing, the operation of closing the housing, which is required as a matter of principle, is integrated in one working step by virtue of fitment of the actuating element.

Preferably the cover of the circuit housing is in the form of a rotary regulator which is rotatable about an axis member mounted in the housing and can serve, for example, for adjusting the volume of the headset. Particularly preferred here is a circular configuration of the cover, with the housing preferably being of a shallow circular-cylindrical configuration. In accordance with the invention, that structure combines a plurality of production-engineering and ergonomic advantages. For, on the one hand, the rotationally symmetrical configuration of the housing and the cover is advantageous in regard to production engineering while on the other hand the assembly affords an access of large area for equipping the circuit housing when the cover is removed. After fitment of the cover the entire side of the housing formed by the cover can then ergonomically advantageously serve as a rotary actuating knob, in which case even the entire periphery at the edge of the cover can serve for gripping purposes, if preferably the periphery of the cover projects somewhat beyond the periphery of the preferably coaxial housing.

So that the adjusted position can also be already read off at the actuating element, in particular the rotary volume knob, the cover as the actuating element preferably has a scale cooperating with a marking on the housing. In that case, the cover as the rotary regulator can preferably be fitted on to a potentiometer of the circuit and can actuate the potentiometer. In that case, the connection of the cover to the potentiometer is preferably in the form of a slipping clutch. That makes it easily possible during fitment of the cover to align the scale on the cover in relation to the marking on the housing. For that purpose, the cover is fitted with its slipping clutch on to the potentiometer and, for example for zero setting, rotated as far as the zero abutment of the potentiometer and then, with the slipping clutch slipping, further rotated until the associated zero marking is reached on the scale. Or, when the rotary knob in its direction of rotation reaches its zero marking before the zero abutment of the potentiometer, the rotary knob is not simply rotated with the slipping clutch slipping but it is now rotated in the opposite direction and in so doing now entrains the potentiometer in that direction of rotation. Now—if preferably the angle of rotation of the potentiometer and the angular range marked by the scale are of the same magnitude—the potentiometer reaches its extreme value abutment in that direction of rotation before the rotary knob so that, with the slipping clutch slipping, the rotary knob is rotated as far as the scale marking corresponding to the extreme value abutment of the potentiometer and can thus be finally aligned with the potentiometer in that direction of rotation.

The cover can preferably be transmissive for infrared rays. In regard to production engineering, that advantageously avoids the requirement of providing a window for infrared signal transmission if the circuit is equipped with an infrared transmitter/receiver for signal transmission.

In accordance with the invention the circuit housing may also have one or more further actuating elements of the circuit. They can be in particular buttons which, for example, switch a microphone which is possibly also disposed in the circuit housing. Or they serve, for example, for actuation of a radio receiver frequency search procedure if the circuit is designed for example for HF-radio signal transmission. It is however also possible to consider further rotary regulators which for example can control the balance between the acoustic transducers for the left ear and the right ear.

The further actuating element can preferably be arranged in a recess at the outside of the housing. That advantageously prevents inadvertent actuation of the element. In that respect, making the recess of a sufficiently wide configuration, in the form of a gripping trough or depression, is advantageous in terms of comfortable actuation of the actuating element. That design configuration is particularly advantageous for actuating elements at the rear side of the circuit housing, that is to say at the side which bears against the chest of the user, while the oppositely disposed front side is easily accessible with the cover according to the invention as the actuating element. This arrangement of further actuating elements also at the rear side, which is possible in accordance with the invention, affords the advantage that the actuating elements there are not visible when the headset is being worn and are therefore optically inconspicuous, which is particularly suitable for elements which are to be actuated less frequently.

In accordance with the invention, a chin loop headset can have the circuit housing according to the invention, having the described features. However, the circuit housing according to the invention—for example equipped with a standardized jack socket—can also be used together with a commercially available loop or ear push-in headset.

### BRIEF DESCRIPTION OF THE DRAWINGS

The present invention is described hereinafter with reference to the accompanying drawings in which:

FIG. 1 shows the rear side of a chin loop headset according to the invention with circuit housing;

FIG. 2 shows a front view of a circuit housing according to the invention;

FIG. 3 shows a side view in section of the circuit housing according to the invention as shown in FIG. 2; and

FIG. 4 shows a side view in section of the circuit housing according to the invention in a modification in relation to FIG. 2.

### DESCRIPTION OF THE PREFERRED EMBODIMENTS

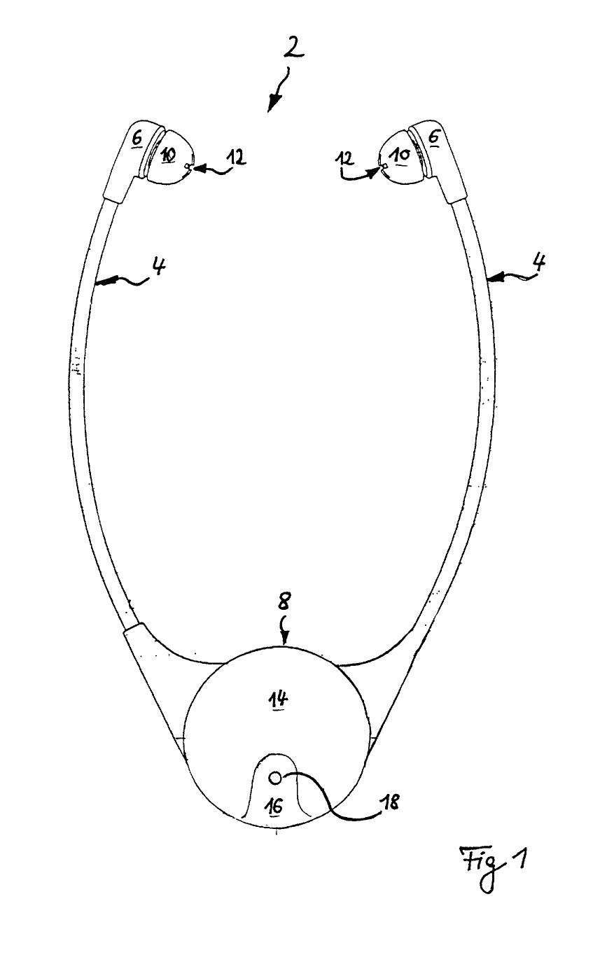

Referring to FIG. 1, shown therein is a chin loop headset 2 comprising two side pieces 4 and two acoustic transducers 6 at the upper ends of the side pieces 4. At their lower ends the side pieces are connected together at a housing 8 and thus form an upwardly open bay-like configuration. In this case the side pieces 2 are curved arcuately outwardly and the acoustic transducers 4 at the upper ends of the side pieces are directed inwardly with ear pads 10 which also face inwardly into the bay-like configuration formed in that way. At their inward tips the ear pads 10 each have a respective passage 12 comprising two crossed slots in order to guarantee a good acoustic connection from the transducers 6 through the ear pads 10 in the direction of the ears (not shown).

The upper ends of the side pieces 4 with the acoustic transducers 6 and the ear pads 10 can be moved elastically away from each other, by the side pieces 2 being transversely outwardly elastically deformable over their arcuate length. In that way the bay-like configuration formed by the side pieces 2 can be elastically enlarged and the ear pads 10 at the acoustic transducers 6 can be fitted by the user into his ears, in which case the side pieces 2 go along the cheeks of the user downwardly to the chin where, under the chin, the housing as the connection between the lower ends of the side pieces 2 rests on the chest (not shown) of the user, more specifically lying thereon with the circular rear side 14, which is visible in FIG. 2, of the substantially circular-cylindrical housing 8. In the region of its downwardly facing edge, provided in the rear side 14 is a recess 16 as an actuating trough for a button 18. It extends from the lower edge of the rear side 14 in a direction towards the center point thereof. In the case of this design configuration, a user can lift the housing 8 at its lower edge in the region of the trough 16 and from there feel forwardly in the trough 16 to the button 18 in order to actuate the latter. The button 18 actuates a circuit which is arranged concealed in the housing 8.

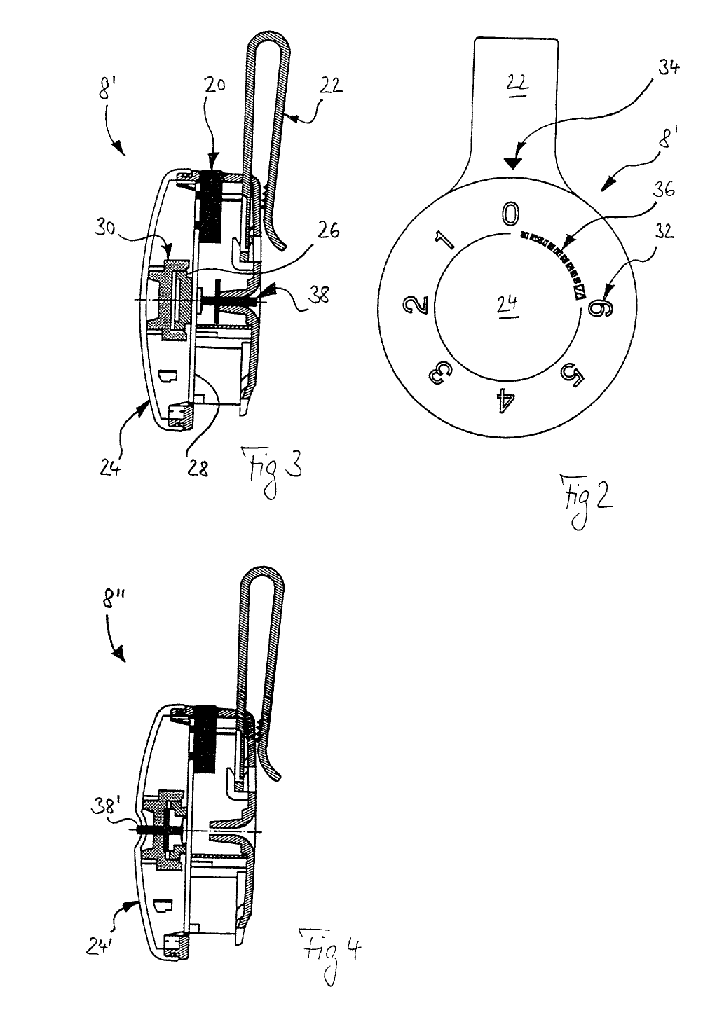

The front side, which is not visible in FIG. 1, of the housing 8 is designed in a manner corresponding to the view in FIG. 2. Shown therein as a plan view of a circuit housing 8′ according to the invention is an alternative embodiment of the invention. Here, the circuit housing 8′ does not have its own side pieces with acoustic transducers—that is to say it does not have its own headset—but it has at the top a 3.5 mm socket 20 (FIG. 3) for a stereo jack plug. In addition the circuit housing 8′ has a hook-shaped clamping clip 22 which projects forwardly from its upper edge for fitting the circuit housing for example to the breast pocket of a shirt or a blouse.

Referring to FIGS. 2 and 3, it can be seen that the substantially circular-cylindrical housing 8′ has a circular cover 24 which is in the form of a rotary regulator. The cover 24 completely covers over the front face of the housing so that its annular edge contour can be easily gripped for rotational actuation thereof. The cover 24 actuates a potentiometer 26 of an electrical circuit 28 of which only the circuit board 28 is shown in FIG. 3 for the sake of clarity of the drawing. Mounted on the circuit board 28 for signal transmission purposes is an infrared receiver and the cover 24 is transmissive of infrared for signal transmission purposes. The cover 24 is fitted by way of a slipping clutch 30 on to the shaft 26 of the potentiometer which is mounted rotatably in the housing 8′ on the circuit 28.

FIG. 2 shows on the outside of the cover 24 a scale 32 which cooperates with a marking 22, 34 on the housing 8′. The value ‘0’ of the scale which is marked by the arrow 34 and the clamping clip 22 is additionally also marked by virtue of its readability when not twisted in some manner, in the illustrated position, which is also already to be interpreted as a marking, in accordance with the invention. In regard to that orientation of the scale 32 it is now possible to see the position of the cover 24, into which it is twisted in relation to the rest of the housing 8′ and in which it has correspondingly actuated the potentiometer 26 by virtue of such twisting movement.

Advertising printing 36 is provided on the outside of the cover 24 and on the outside of the housing 8 generally, for example also on its rear side 14.

FIG. 3 shows on the axis of the circular-cylindrical housing 8′ a micro-button 38 which projects centrally out of the rear side 14′ of the housing 18′ for actuation purposes. FIG. 4 shows in relation thereto a variant in which a micro-button 38′ is to be actuated centrally at the front side of the housing 8″, that is to say centrally on the cover 24′.

While the foregoing description and drawings represent the present invention, it will be obvious to those skilled in the art that various changes may be made therein without departing from the true spirit and scope of the present invention.

What is claimed is:

1. A circuit housing having an electrical circuit for a headset, such as for a chin loop headset, comprising that the housing has a cover which is in the form of an actuating element of the circuit.

2. The circuit housing according to claim 1, wherein said cover is rotatable in the form of a rotary regulator, for regulation of the volume, about an axis member mounted in the housing.

3. The circuit housing according to claim 1, wherein said cover has a scale which cooperates with a marking on the housing.

4. The circuit housing according to claim 1, wherein said cover is connected to a potentiometer of the circuit by a slipping clutch.

5. The circuit housing according to claim 1, wherein said housing is circular-cylindrical.

6. The circuit housing according to claim 1, wherein said cover is circular.

7. The circuit housing according to claim 1, wherein said cover is transmissive for infrared rays.

8. The circuit housing according to claim 1, wherein provided on the outside of the housing is at least one further actuating element of the circuit.

9. The circuit housing according to claim 8, wherein said further actuating element is a button.

10. The circuit housing according to claim 8, wherein said actuating element is arranged in a recess at the outside of the housing.

11. The circuit housing according to claim 8, wherein said further actuating element is arranged at the rear side of the housing which is in opposite relationship to the cover.
